(19) United States
(12) Patent Application Publication
(10) Pub. No.: US 2026/0284941 A1
(43) Pub. Date: Sep. 24, 2026

(54) METHOD FOR PRODUCING CORRUGATED LAMINATED PANELS

(71) Applicant: DOW GLOBAL TECHNOLOGIES LLC, Midland, MI (US)

(72) Inventors: Mirella CORONEO, Correggio (IT); Andreas OTTENS, Ahlen (DE); Christopher J. SILER, Midland, MI (US)

(21) Appl. No.: 19/490,927

(22) PCT Filed: Jun. 7, 2024
(86) PCT No.: PCT/US2024/032893

§ 371 Date: Dec. 6, 2025

(30) Foreign Application Priority Data
Jun. 9, 2023 (IT) 102023000011865

(51) Int. Cl. B29C 44/32; B29C 44/28; B29L 7/00; B29L 9/00

(52) U.S. Cl. CPC B29C 44/326; B29C 44/28; B29L 2007/002; B29L 2009/00

(57) ABSTRACT

Corrugated laminated panels (1) are produced by dispensing a reactive foam formulation (4) onto a corrugated facing layer (2), positioning a top facing layer (3) above the reactive foam formulation and then curing the foam formulation so it expands to occupy the space between the facing layers to form a cured foam layer adhering to both facing layers. The reactive foam formulation is dispensed only onto flat areas of the corrugated facing layers, and not the corrugations (13). Some of the reactive formulation drains into the corrugations where it cures to fill the corrugations with foam. The panels have few defects and exhibit good adhesion between the cured foam and the facing layers.

This invention relates to methods for producing corrugated laminated panels.

Double-faced laminated panels are materials that include a polymer foam layer and a facing layer bonded to one or both sides of the foam layer. These products are useful as thermal insulation panels due to the insulating properties of the foam layer. They are often used to construct walls and as roofing panels.

The panels can be made industrially through a continuous process commonly known as double band lamination. In this process, a reactive foam formulation is dispensed onto a moving bottom facing layer from the outlets of a stationary distributor. The outlets are arranged across the width of the bottom facing layer. This motion produces from each outlet a strip of foam formulation on the bottom facing layer. The dispensed foam formulation cures on top of the bottom facing layer to form the cured polymer foam layer, which bonds to the bottom facing layer. A top facing layer typically is provided into the process to form a double-faced “sandwich” structure. In that case, the top facing layer also moves generally horizontally, parallel to and in the same direction as the bottom facing layer, to define a gap between the top and bottom facing layers. The foam formulation expands to fill that gap as it cures, thereby bonding to both of the facing layers. The gap between the top and bottom facing layers defines the thickness of the foam layer.

This process works well when the top and bottom layers are both flat. However, some laminated panels have corrugations on one or both sides. Corrugated panels have greater mechanical strength than similarly made flat panels. The greater mechanical strength makes them more suitable in load-bearing applications such as roof panels, in which the panels often are disposed horizontally or inclined from the vertical and have to bear their own weight and/or other applied loads. Corrugated panels produced in the double band lamination process have large numbers of defects in the foam layers, particularly at the interface between the foam layer and the top facing layer. The defects include void spaces, uneven distribution of the foam layer, inadequate adhesion to the facing layers, and poor aesthetics. A way to reduce or eliminate these defects would be of great benefit.

Applicant has discovered that defects in corrugated panels made in the double band lamination process can be reduced quite significantly by orienting a bottom corrugated facing layer in a particular way and by dispensing the reactive foam formulation only onto flat areas of the bottom corrugated facing layer, between the corrugations. Accordingly, in one aspect, the invention is process for making a corrugated laminated panel. The process comprises:
I. continuously moving a corrugated facing layer in a linear direction of movement beneath a distributor having multiple outlets for dispensing jets of a reactive foam formulation onto the corrugated facing layer, wherein (i) the corrugated facing layer comprises multiple flat sections separated by multiple parallel corrugations, the flat sections having a width greater than or equal to the widths of the multiple parallel corrugations, (ii) the corrugated facing layer is disposed with the flat sections facing upwardly and (iii) the multiple parallel corrugations extend downwardly from the flat sections and are oriented in the linear direction of movement of the corrugated facing layer beneath to the distributor;
II. forming a reactive foam formulation layer by continuously dispensing jets of reactive foam formulation from the multiple outlets of the distributor only onto the flat sections of the corrugated facing layer as the corrugated facing layer moves beneath the distributor, such that the reactive foam formulation is dispensed onto each of the flat sections at rates per unit width that differ from each other by no more than 25%, whereby a portion of the reactive foam formulation dispensed onto the flat sections drains into the multiple parallel corrugations;
III. positioning a top facing layer above the reactive foam formulation layer and parallel to the corrugated facing layer to define a gap therebetween, and
IV. curing the reactive foam formulation layer between the corrugated facing layer and the top facing layer to expand the foam formulation to fill the entire gap between the corrugated facing layer and the top facing layer, including the corrugations, and convert the reactive foam formulation to a cured foam layer, to produce the corrugated laminated panel comprising the cured foam layer adhered to the corrugated facing layer and the top facing layer.

Corrugated panels made in accordance with the invention have remarkably few defects. Good adhesion to both facing layers is obtained. Surprisingly, the corrugations are filled and defects at the interface of the cured polymer foam layer and the top facing layers are greatly reduced.

Distributors used in conventional processes for producing non-corrugated panels typically are adapted to dispense a line of jets of reactive foam formulation evenly across the width of the bottom facing layer. If used without adaptation to produce corrugated panels, the reactive foam formulation is dispensed unevenly onto flat areas and the corrugations of the corrugated facing layer. By blocking off certain of the outlets, and/or fitting certain outlets with restriction nozzles and/or directional nozzles, existing or readily available distributors can be modified to direct the jets of reactive foam formulation onto only the flat surfaces of the corrugated facing layer, and at the same or nearly the same rates per unit width of the respective facing layers. Such restrictions and nozzles preferably are removable and replaceable, so different outlets can be modified as needed to accommodate panels having different geometries, different numbers of corrugations and different spacings or locations of corrugations. This attribute avoids the cost of designing and supplying a specific distributor for each particular corrugated laminated panel. Additionally, the same distributor can be used to make flat (non-corrugated) panels, by removing the restrictions and/or nozzles.

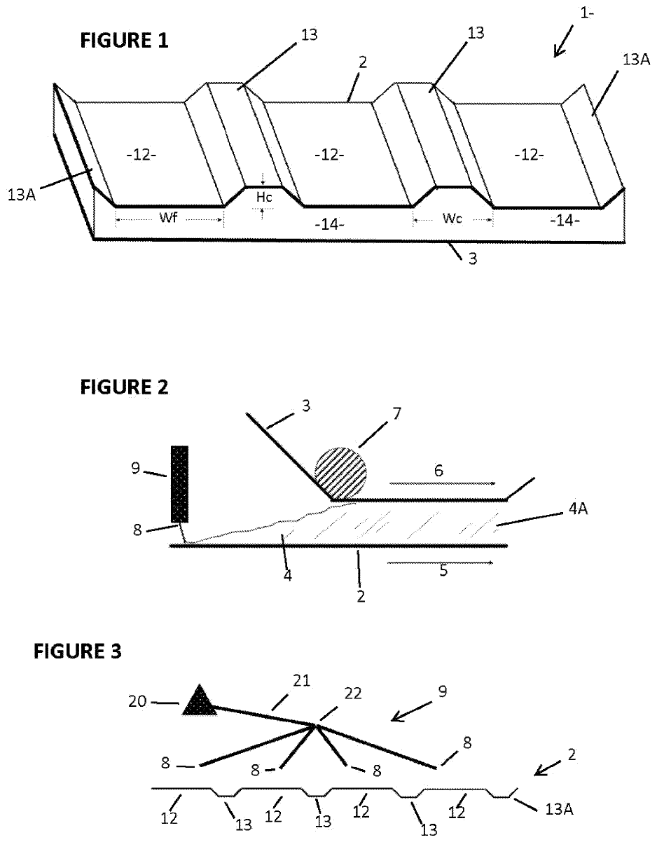

FIG. 1 is a perspective view of a corrugated laminated panel made in accordance with the invention.

FIG. 2 is a schematic view diagram of a double belt lamination process adaptable for use in this invention.

FIG. 3 is a schematic diagram of a corrugated laminated panel manufacturing process of the invention.

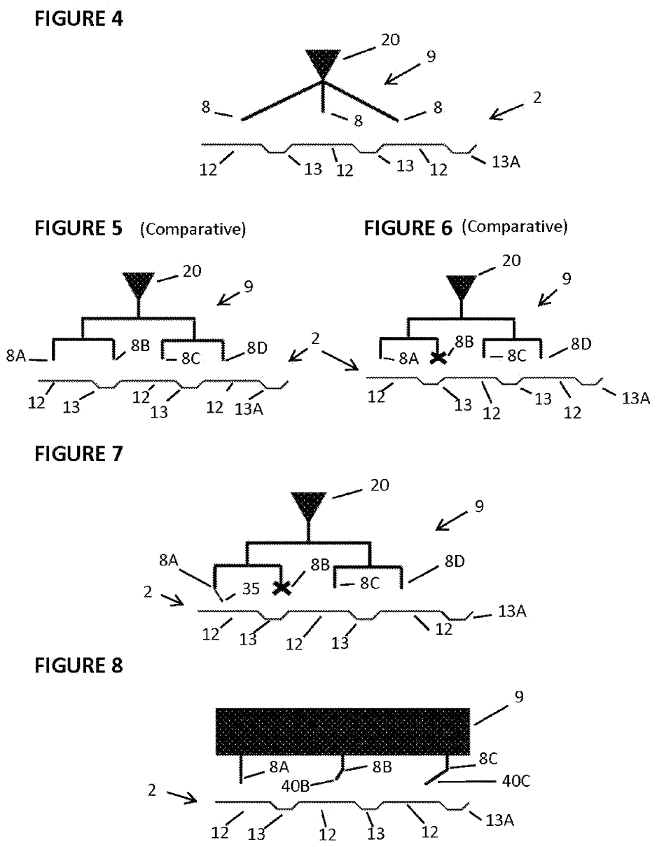

FIG. 4 is a schematic diagram of a second embodiment of a corrugated laminated panel manufacturing process of the invention.

FIG. 5 is a schematic diagram of a comparative method of distributing reactive foam formulation onto a corrugated facing layer.

FIG. 6 is a schematic diagram of a second comparative method of distributing reactive foam formulation onto a corrugated facing layer.

FIG. 7 is a schematic diagram of a method of distributing reactive foam formulation onto a corrugated facing layer in accordance with the invention.

FIG. 8 is a schematic diagram of a method of distributing reactive foam formulation onto a corrugated facing layer in accordance with the invention.

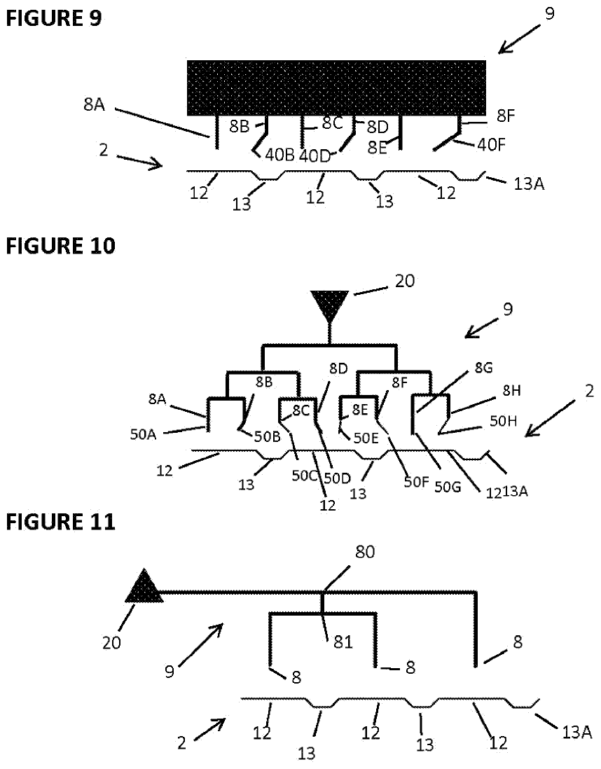

FIG. 9 is a schematic diagram of a method of distributing reactive foam formulation onto a corrugated facing layer in accordance with the invention.

FIG. 10 is a schematic diagram of a method of distributing reactive foam formulation onto a corrugated facing layer in accordance with the invention.

FIG. 11 is a schematic diagram of another method of distributing reactive foam formulation onto a corrugated facing layer in accordance with the invention.

Turning to FIG. 1, corrugated laminated panel 1 includes corrugated facing layer 2 and opposing facing layer 3. Cured foam layer 14 resides between corrugated facing layer 2 and opposing facing layer 3, filling the space therebetween (including the area under corrugations 13 and 13A), and is adhered to both of the facing layers to form a sandwich structure.

Corrugated facing layer 2 includes multiple flat sections 12, which are separated by parallel corrugations 13. Parallel corrugations 13 extend outwardly from the surface defined by flat sections 12 by a height H_{c}. Parallel corrugations 13 have a width W_{c}, the width for purposes of this invention being the width of the corrugations 13 at their widest point. Flat areas have a width W_{f}, which is preferably greater than or equal to W_{c}. H_{c} may be, for example, at least 15 mm, at least 25 mm or at least 30 mm and may be, for example, up to 100 mm, up to 75 mm, up to 50 mm or up to 40 mm. W_{c} may be, for example, at least 10 mm, at least 15 mm or at least 20 mm and may be, for example, up to 100 mm, up to 75 mm or up to 60 mm. W_{c} may be, for example, at least 50 mm, at least 75 mm, at least 100 mm or at least 150 mm and may be, for example, up to 400 mm, up to 350 mm, up to 300 mm or up to 250 mm, again preferably being greater than or equal to W_{c}. The parallel corrugations shown in FIG. 1 and subsequent figures have trapezoidal cross-sections, but this is not necessary. Parallel corrugations 13 and lateral corrugations 13A when present may have any useful cross-section such as rectangular (including square), other polygonal cross-section, semi-circular, semi-elliptical, and the like.

In the particular embodiment shown in FIG. 1, the number of flat areas 12 is arbitrarily shown as three, and the number of parallel corrugations 13 separating flat areas 12 is arbitrarily shown as two. The number of flat areas 12 may be any greater number, such as at least 4, at least 5 or at least 6, but the number of flat areas 12 generally will be up to 12, up to 10 or up to 8. The number of parallel corrugations 13 may up to 11, up to 9, up to 7, up to 5, up to 4 or up to 3. Flat areas 12 may include ridges or other raised areas having a maximum height of 10 mm, preferably 8 mm. Raised features having heights of 10 mm or less are not considered as corrugations for purposes of this invention, and otherwise flat regions that contain such small raised areas are considered as “flat” areas for purposes of this invention.

In the particular embodiment shown, corrugated facing layer 2 further includes lateral corrugations 13A, each of which extends along one edge of corrugated panel 10 parallel to parallel corrugations 13. Lateral corrugations 13A are optional. Either or both of lateral corrugations 13A may be absent.

In the embodiment shown in FIG. 1, opposing facing layer 3 is flat, i.e., non-corrugated. Opposing facing layer 3 instead may be corrugated in the same manner as described with respect to corrugated facing layer 2. If corrugated, opposing facing layer 3 is preferably oriented during manufacture with the facing areas facing downward, so the facing areas come in contact with the reactive foam layer as it expands and occupies the region between corrugated facing layer 2 and opposing layer 3 and become adhered to cured polymer foam 14.

Cured foam layer 14 may have a thickness, for example, of at least 12 mm, at least 25 mm or at least 50 mm and, for example, up to 150 mm, up to 100 mm or up to 75 mm. The thickness of cured foam layer 14 is the distance between flat areas 12 and opposing facing layer 3; if opposing facing layer 3 is corrugated, the thickness of cured foam layer is the distance between flat areas 12 of corrugated facing layer 2 and flat areas of opposing facing layer 3; i.e., the height of the cured foam layers within the corrugations is disregarded. Cured foam layer 14 is a polymeric foam produced by curing a reactive foam formulation. The foam density may be, for example, at least 24 kg/m³, at least 30 kg/m3 or at least 32 kg/m3 and may be, for example, up to 160 kg/m³, up to 120 kg/m³, up to 80 kg/m³, up to 64 kg/m3 or up to 48 kg/m³. Cured foam layer 14 preferably comprises a thermoset isocyanate-based foam that contains urethane, urea and/or isocyanurate groups. Cured foam layer 14 preferably has a closed-cell structure.

FIG. 2 schematically illustrates a generic belt lamination process adaptable for producing corrugated laminated panels in accordance with this invention. Corrugated facing layer 2 travels continuously and substantially horizontally (for example, from zero to as much as +25 degrees from the horizontal) beneath distributor 9, in a linear direction indicated by arrow 5. As modified according to this invention, corrugated facing layer 2 is as generally described above in connection with FIG. 1; for ease of illustration the corrugations are not shown in FIG. 2. Corrugated facing layer 2 may be carried on a belt or other moving platform; may be attached to a tenter frame, may be pulled through the process using a winding roller or other apparatus, or is otherwise mechanically moved through the process in a linear direction, passing beneath distributor 9.

Corrugated facing layer 2 may be produced continuously in an upstream operation (not shown), by corrugating a flat sheet. Such a continuously produced corrugated facing layer may be fed continuously into the laminated panel production process shown in FIG. 2, or other suitable production process.

Reactive foam formulation 4 is supplied via distributor 9 to outlet 8, from which it is dispensed onto corrugated facing layer 2 as corrugated facing layer 2 travels in the indicated horizontal direction. For simplicity of illustration, only one outlet 8 is shown in FIG. 2; as modified in accordance with this invention, the distributor comprises multiple outlets positioned across the width of corrugated facing layer 2, each one dispensing a jet of reactive foam formulation onto flat areas 12 of corrugated facing layer 2. The “width” of corrugated facing layer 2 is the horizonal dimension of corrugated facing layer 2 perpendicular to the direction of travel of corrugated facing layer 2. Similarly, the “width” of each flat area 12 is the distance between the adjacent parallel corrugations or, in the case of a flat area along a lateral edge of the corrugated facing layer 12, the distance between such lateral edge and the parallel corrugation adjacent to the flat area.

The jets of reactive foam formulation are dispensed onto the flat areas at approximately equal rates per unit width, i.e., the ratio Rᵥ/width (where Rᵥ is the volume of reactive foam formulation dispensed on a particular flat area per unit time and width is the width of that flat area) for each flat area is no greater than 25% more or less, more preferably no greater than 10% more or less or no greater than 5% more or less than the Rᵥ/width ratio for every other flat area. Most preferably, the reactive foam formulation is dispensed onto each of the flat sections at the same rate per unit width, i.e., Rᵥ/width is the same for each flat section.

Upon being dispensed onto corrugated facing layer 2, reactive foam formulation 4 is carried along with corrugated facing layer 2. In this invention, a portion of reactive foam formulation 4 drains from flat areas 12 into parallel corrugations 13 (and lateral corrugations 13A when present) of corrugated facing layer 2 before or at the same time as reactive foam formulation 4 expands. Reactive foam formulation 4 expands to fill parallel corrugations 13 and lateral corrugations 13A (when present) and expands upwardly to occupy the region between corrugated facing layer 2 and opposing facing layer 3, thereby forming layer 4A of reactive foam formulation. Opposing facing layer 3 is positioned above the top surface of of reactive foam formulation 4, parallel to corrugated facing layer 2 so as to define a gap therebetween. Opposing facing layer 3 preferably also travels continuously in the direction indicated by arrow 6, i.e., in the same direction as corrugated facing layer 2 travels, and preferably at the same linear speed. Opposing facing layer 3 can be moved through the process using any of the methods and apparatus as described above with regard to moving corrugated facing layer 2.

As shown, the vertical gap between corrugated facing layer 2 and opposing facing layer 3 is established mechanically, in this particular embodiment by passing opposing facing layer 3 under roller 7. Although only a single roller is shown, multiple rollers 7 may be present, and/or other mechanical elements may be present to position opposing facing layer 3 to establish the gap. In the double belt lamination process shown, the vertical distance so established defines the thickness of foam formulation layer 4A, as foam formulation 4 expands upwardly until further upward expansion is constrained by opposing facing layer 3. Foam formulation layer 4A then cures to form a cured foam layer. Upon curing, the resulting cured foam layer 14 (FIG. 1) occupies the region between corrugated facing layer 2 and opposing facing layer 3, including parallel corrugations 13, lateral corrugations 13A (when present), and any corrugations as may be present in opposing facing layer 3. Pressure may be applied to opposing facing layer 3 and to corrugated facing layer 2, such as via a double belt or other mechanical means, or via air pressure, to maintain the desired spacing between corrugated facing layer 2 and opposing facing layer 3, and therefore the overall thickness of corrugated laminated panel 1. A double belt laminator is an example of an apparatus suitable for performing the lamination process.

The orientation of corrugated facing layer 2 relative to distributor 9 and outlets 8 as corrugated facing layer 2 moves through the inventive process is shown in each of FIGS. 3-4 and 7-11.

In FIG. 3, corrugated facing layer 2 is shown having, for purposes of illustration, four flat areas 12, separated from each other by three parallel corrugations 13. As shown, flat areas 12 are all of equal width, as are parallel corrugations 13. Lateral corrugation 13A extends along one edge of corrugated facing layer 2 of FIG. 3. Distributor 9 is positioned above corrugated facing layer 2 as corrugated facing layer 2 is moved beneath distributor 9 during operation in a direction parallel to the corrugations 13 (and 13A if present). During operation, a reactive foam formulation is formed within mixhead 20 and transferred through line 21 to distributor 9. Mixhead 20 typically includes two or more inlets for the introduction of starting materials that are to be combined in the mixhead to produce a reactive foam formulation which takes the form of a fluid mixture. Components introduced into mixhead 20 are supplied via supply systems (not shown) that may include various conduits, pumps, metering devices, storage devices, heating and/or cooling devices, operational systems (including computerized operational systems) as may be useful or desired to deliver the respective components to mixhead 20 in correct ratios and under suitable temperature and/or pressure conditions.

Turning back to FIG. 3, distributor 9 divides the reactive foam formulation produced in mixhead 20 into four separate streams at branch point 22, for delivery through outlets 8 onto corrugated facing layer 2. Distributor 9 as shown has four outlets 8, each of which is positioned above a single flat area 12 of corrugated facing layer 2. The geometries (i.e., lengths and inside diameters) of each of outlets 8 and the respective flow paths leading to each of outlets 8 preferably are such that reactive foam formulation is dispensed from each of outlets 8 at approximately equal rates per unit width of the respective flat areas 12 onto which they dispense the reactive foam formulation, as described before. None of the reactive foam formulation is dispensed directly into any of parallel corrugations 13 or lateral corrugation 13A.

In each of the arrangements shown in each of FIGS. 4-13, corrugated facing layer 2 is shown having, for purposes of illustration, three flat areas 12, separated from each other by two parallel corrugations 13. As shown, flat areas 12 are all of equal width, as are parallel corrugations 13. Lateral corrugation 13A extends along one edge of corrugated facing layer 2 in each of FIGS. 4-11. In each case, distributor 9 is positioned above corrugated facing layer 2 as corrugated facing layer 2 is moved beneath distributor 9 during operation.

During operation of the FIG. 4 embodiment, a reactive foam formulation is formed within mixhead 20 and transferred directly to distributor 9. Distributor 9 divides the reactive foam formulation into three separate streams for delivery through outlets 8 onto corrugated facing layer 2. Distributor 9 as shown has three outlets 8, each of which is positioned above a single flat area 12 of corrugated facing layer 2. As before, the geometries (i.e., lengths and inside diameters) of each of outlets 8 and flow paths leading to the respective outlets are such that reactive foam formulation is dispensed from each of outlets 8 at approximately equal rates per unit width of the respective flat areas 12 onto which they dispense the reactive foam formulation as described before. None of the reactive foam formulation is dispensed directly into any of parallel corrugations 13 or lateral corrugation 13A.

FIGS. 5 (comparative), 6 (comparative) and 7 (inventive) illustrate arrangements for distributing reactive foam formulation onto corrugated facing layer 2 through a branched distributor 9 having for purposes of illustration four outlets 8A, 8B, 8C and 8D. Branched distributors of this type are described in detail in FIG. 3 and accompanying text of WO 2021/045888, incorporated herein by reference. Such branched distributors are designed such that the flow paths through the distributor to the outlets all have the same lengths and inside diameters, so reactive foam formulation is dispensed at the same rate through each of the outlets.

In the comparative arrangement shown in FIG. 5, outlet 8B is positioned directly above and dispenses reactive foam formulation onto one of parallel corrugations 13 of corrugated facing layer 2. In FIG. 6, outlet 8B is similarly positioned about one of parallel corrugations 13 but is blocked off so no reactive foam formulation is dispensed though that outlet. Reactive foam formulation is dispensed only onto flat areas 12 through the remaining three outlets 8A, 8C and 8D. In the FIG. 6 arrangement, flow through the remaining three outlets becomes unevenly distributed due to outlet 8B being blocked off. In this particular case, the flow rate through outlet 8A is increased relative to outlets 8C and 8D, leading to a greater amount of reactive foam formulation being dispensed onto the flat area beneath outlet 8A.

The embodiment shown in FIG. 7 addresses the problem of uneven flow rates by fitting outlet 8A with restriction nozzle 35. Restriction nozzle 35 reduces the flow rate of the reactive foam formulation through outlet 8A, thereby balancing the flows through outlets 8A, 8C and 8D to provide equal or nearly equal flow rates through each of those outlets. Outlets 8A, 8C and 8D all dispense reactive foam formulation only onto the flat areas 12 and not into corrugations 13 or 13A.

FIGS. 8 and 9 illustrate the use of directional nozzles to adapt conventional distributors that might otherwise dispense reactive foam formulation into one or more parallel corrugations 13 of corrugated facing panel 2. In the FIG. 8 embodiment, outlets 8B and 8C are fitted with directional nozzles 40B and 40C so each dispenses reactive foam formulation onto a flat area 12. In the FIG. 9 embodiment, outlets 8B, 8D and 8F are positioned over parallel corrugations; directional nozzles 40B, 40D and 40F redirect reactive foam formulation dispensed through those outlets onto flat areas 12.

FIG. 10 illustrates yet another arrangement of the invention. Distributor 9 is a branched type as generally described in WO 2021/04588, comprising a series of conduits that split the flow of reactive foam formulations in half three times to produce eight streams that are dispensed from eight equally spaced outlets 8A-8H. All paths through distributor 9 to outlets 8 are the same length and have the same internal geometry. Outlets 8A, 8B, 8D and 8G are positioned directly above flat areas 12 of corrugated facing panel 2. Outlets 8C, 8F and 8H are positioned above parallel corrugations 13 or lateral corrugation 13A. Outlet 8E is positioned above the junction of a flat area 13 and a parallel corrugation 12.

In the embodiment shown in FIG. 10, outlets 8A-8H are fitted with corresponding nozzles 50A-50H. Nozzles 50B and 50D are directional nozzles, directing a jet of reaction foam formulation dispensed through those nozzles onto the flat areas 12 directly below each of them. Nozzles 50C, 50E, 50F and 50H are both directional and restrictive, each directing a jet of reactive foam formulation onto a flat area 12, at reduced rates relative to nozzles 50A, 50B, 50D and 50G. The combined flow rates through nozzles 50A+50B=50C+50D+50E=50F+50G+50H, allowing for the same amount of reactive foam formulation to be dispensed per unit time onto each of the flat areas, even though one of the flat areas is served by only two nozzles and the others are served by three nozzles.

The embodiments shown in FIGS. 7-10 illustrate various ways in which a distributor designed for producing flat panels can be adapted for use in this invention through the use of blocking and/or directional and/or restrictive nozzles. In an analogous way, distributors having alternative designs and/or numbers of openings can be adapted for use in this invention. Similarly, distributors designed for flat panel use can be adapted in an analogous way for dispensing a reactive foam formulation onto corrugated facing panels having more or fewer flat areas 12 and parallel corrugations 13 and optionally lateral corrugations 13A. Accordingly, with proper adaptation to dispense reactive foam formulation only onto flat areas of a corrugated facing layer, distribution systems such as a distributor bar as described in US Published Patent Application No. 2014/00417412, a rake-type distributor bar as described in US Published Patent Application No. 2017/0285619 and/or US 2010/0080900, a jointed casting rake/accommodation element assembly as described in U.S. Pat. No. 9,718,223, an apparatus as described in German Utility Model 20 2011 001 109 U1 and/or 20 2009 015 838U1, an apparatus as described in WO 2008/018787, or a distributor as described in WO 2021/04588, all can be used with the invention.

Yet another exemplary arrangement is shown in FIG. 11. Distributor 9 is positioned above corrugated facing layer 2 during operation as corrugated facing layer 2 is moved beneath it. During operation, a reactive foam formulation is formed within mixing head 20 and transferred to distributor 9. Distributor 9 divides the reactive foam formulation into three separate streams at branch points 80 and 81, for delivery through outlets 8 onto corrugated facing layer 2. Distributor 9 as shown has three outlets 8, each of which is positioned above a single flat area 12 of corrugated facing layer 2. The geometries, (i.e., lengths and inside diameters) of each of outlets 8 and the associated flow paths to each of those outlets 8) preferably are such that equal or approximately equal amounts of reactive foam formulation are dispensed per unit time from each of outlets 8, as described before. Alternatively, one or more of outlets 8 may be fitted with a restrictive nozzle to produce equal flow rates through each of outlets 8. None of the reactive foam formulation is dispensed directly into any of parallel corrugations 13 or lateral corrugation 13A.

Reactive foam formulation is dispensed in accordance to the invention from outlets 8 of distributor 9 only onto the flat areas 12 of corrugated facing layer 2. A portion of the dispensed reactive foam formulation drains into parallel corrugations 13 and lateral corrugations 13A (when present) before or during foam expansion. The reactive foam formulation expands to fill parallel corrugations 13 and lateral corrugations 13A (when present), expands upwardly to fill the space between corrugated facing layer 2 and opposing facing layer 3, and cures to produce cured foam layer 14 (FIG. 1) adhered to the corrugated facing layer and the top facing layer.

A preferred reactive foam formulation includes components comprising at least one polyisocyanate, at least one physical blowing agent, at least one polyol and at least one catalyst. Curing conditions are selected such that the blowing agent volatilizes and the reactive components of the reactive foam formulation react to produce a polymer foam. The conditions typically include a temperature above the boiling temperature of the physical blowing agent at the pressures employed. The polyisocyanate and polyol(s) typically will react spontaneously when mixed, even at room temperature, and the exothermic heat of reaction is often sufficient to produce the temperature needed to volatilize the physical blowing agent. Therefore, it is often necessary only to produce the reactive foam formulation and dispense it onto the corrugated facing sheet at or about room temperature, such as 10 to 35° C., and allow the reaction to complete without further applied heat. However, if desired, the components of the reactive foam formulation can be heated at the time of or prior to combining them and/or at the time of or after dispensing the reactive foam formulation onto the corrugated facing sheet. The elevated temperature may be, for example, 35 to 100° C. Metal facing layers are also typically heated between 20° C. and 80° C. in order to increase the adhesion of the foam to the metal facings. The process of forming the laminated panel may be performed on a heated conveyor, such as a double band laminator in which one or both of the bands are heated, to provide a suitable curing temperature.

The process of the invention may and preferably does include various additional steps (and associated apparatus) as are needed to produce a laminated panel product. The facing layers, particularly metal ones, may be pre-treated to promote good adhesion to the polymer foam or otherwise to facilitate panel manufacture. Examples of pre-treatment steps include decoiling, corona discharge treatment, profiling, heating to the process temperature, and application of an adhesion promoter. Such pretreatment steps can be performed continuously in an upstream operation not shown in FIG. 2, with the pretreated corrugated facing layer 2 being fed continuously into the laminated panel production process shown in FIG. 2, or other suitable production process.

Similarly, the process may and preferably does include one or more downstream steps, such as cutting the laminated panel to a desired length, cooling the laminated panel from the curing temperature, stacking the laminated panels, and wrapping the laminated panels or otherwise preparing them for shipment or storage.

The various components of the reactive foam formulation can be introduced into mixhead 20 individually or as various subcombinations. Typically, the polyisocyanate is introduced into mixhead 20 through one inlet, and the polyol is introduced into mixhead 20 through at least one different inlet. The remaining components can be introduced into mixhead 20 separately, and/or can be introduced together with the polyol. In some embodiments, the physical blowing agent is combined with the polyol upstream of mixhead 20 and introduced into mixhead 20 together with the polyol. The catalyst (and/or other optional ingredients such as a surfactant) can be introduced into mixhead 20 in a similar manner if desired. It is also possible to introduce the catalyst and/or optional ingredients (if any) by combining them with the polyisocyanate upstream of mixhead 20 and introducing them together with the polyisocyanate.

A nucleating gas such as air, nitrogen, hydrogen or argon may be introduced into mixhead 20, separately through its own inlet and/or as a mixture with one or more of the other components, notably the polyol.

Suitable organic polyisocyanates for use in a laminated panel manufacturing process of the invention include aliphatic, cycloaliphatic, araliphatic or aromatic polyisocyanates, or combinations of any two or more thereof. Such may include, for example, alkylene diisocyanates, particularly those having from 4 to 12 carbon atoms in the alkylene moiety, such as 1,12-dodecane diisocyanate, 2-ethyltetramethylene 1,4-diisocyanate, 2-methyl-pentamethylene 1,5-diisocyanate, 2-ethyl-2-butylpentamethylene 1,5-diisocyanate, tetramethylene 1,4-diisocyanate and preferably hexamethylene 1,6-diisocyanate; cycloaliphatic diisocyanates such as cyclohexane 1,3- and 1,4-diisocyanate and any mixture these isomers, 1-isocyanato-3,3,5-trimethyl-5-isocyanato-methylcyclohexane (isophorone diisocyanate), 2,4- and 2,6-hexahydrotoluene diisocyanate and the corresponding isomer mixtures, 4,4′-, 2,2′- and 2,4′-dicyclohexylmethane diisocyanate and the corresponding isomer mixtures, araliphatic diisocyanates such as 1,4-xylylene diisocyanate and xylylene diisocyanate isomer mixtures, and preferably aromatic diisocyanates and polyisocyanates, such as 2,4- and 2,6-toluene diisocyanate and the corresponding isomer mixtures, 4,4′-, 2,4′- and 2,2′-diphenylmethane diisocyanate and the corresponding isomer mixtures, mixtures of 4,4′- and 2,4′-diphenylmethane diisocyanates, polyphenyl-polymethylene polyisocyanates, mixtures of 4,4′-, 2,4′- and 2,2′-diphenylmethane diisocyanates and polyphenylpolymethylene polyisocyanates (crude MDI), and mixtures of crude MDI and toluene diisocyanates. Modified polyisocyanates, i.e., products which are obtained by chemical reaction of organic diisocyanates and/or polyisocyanates, may also be used. Specific examples are ester-, urea-, biuret-, allophanate-, uretoneimine-, carbodiimide-, isocyanurate-, uretdione- and/or urethane-containing diisocyanates and/or polyisocyanates, that contain from 33.6 to 15 percent by weight, preferably from 31 to 21 percent by weight, of isocyanate groups, based on the total weight of the modified polyisocyanate. The organic polyisocyanates may be employed individually or in the form of combinations thereof.

The reactive foam formulation typically includes at least one polyol, i.e., a compound having two or more hydroxyl groups. A wide range of polyols can be used, depending in part on the desired properties of the polymer foam. Useful polyols therefore include polyether polyols, polyester polyols, hydroxyl-terminated polybutadiene rubbers, polyacrylate polyols and polycarbonate polyols, as well as other types. Useful polyols have hydroxyl equivalent weights of about 30 to 3000; however, for laminate panel production it is preferred to use at least one polyol having a hydroxyl equivalent weight of 30 to 1000, especially 125 to 560. The polyols may have hydroxyl functionalities of 2 to 8 or more hydroxyl groups per molecule.

Useful polyether polyols include ethoxylates and/or propoxylates of one or more hydroxyl- and/or amine group containing starters that have an equivalent weight of 30 to 59, including, for example, one or more of ethylene glycol, diethylene glycol, triethylene glycol, 1,2-propane diol, 1,3-propanediol, dipropylene glycol, tripropylene glycol, glycerin, trimethylolpropane, trimethylolethane, neopentyl glycol, 1,6-hexanediol, 1,4-cyclohexanedimethanol, 1,2,6-hexanetriol, monoethanolamine, diethanolamine, triethanolamine, pentaerythritol, erythritol, sorbitol, sucrose, mannitol, N,N,N′,N′-tetrakis(2-hydroxypropyl)-ethylenediamine, diethyl toluenediamine, dimethylthiotoluenediamine and combinations thereof.

Useful polyester polyols may be reaction products of, for example, an organic dicarboxylic acid (or corresponding acid anhydridesor ester) having about 2 to about 12 carbon atoms with a polyhydric alcohol, preferably a diol and/or triol having 2 to 12 carbon atoms, preferably from 2 to 6 carbon atoms. Examples of suitable dicarboxylic acids are succinic acid, glutaric acid, adipic acid, suberic acid, azelaic acid, sebacic acid, decanedicarboxylic acid, maleic acid, fumaric acid, and preferably orthophthalic acid, isophthalic acid, terephthalic acid and the isomeric naphthalene-dicarboxylic acids. The dicarboxylic acids may be used either individually or mixed with one another. Examples of dihydric and polyhydric alcohols used to make the polyester polyol are ethanediol, diethylene glycol, 1,2- and 1,3-propanediol, dipropylene glycol, 1,4-butanediol, 1,5-pentanediol, 1,6-hexanediol, 1,10-decanediol, glycerol, trimethylolpropane. Also useful are modified aromatic polyester polyols such as described in U.S. Pat. No. 6,359,022, which contain one or more pendant aliphatic hydrocarbyl groups that have 6 or more carbon atoms in a straight or branched chain.

Furthermore, polyester polyols made from lactones such as e-caprolactone or hydroxycarboxylic acids such @-hydroxycaproic acid and hydrobenzoic acid may also be employed. Hybrid polyether-polyester polyols such as are described, for example, in WO 2011/137011 are also useful.

Other useful polyols include compounds having 2 to 8 hydroxyl groups, equivalent weights of up to 125 and molecular weights up to 200, such as ethylene glycol, diethylene glycol, triethylene glycol, 1,2-propane diol, 1,3-propanediol, dipropylene glycol, tripropylene glycol, glycerin, trimethylolpropane, trimethylolethane, neopentyl glycol, 1,6-hexanediol, 1,4-cyclohexanedimethanol, 1,2,6-hexanetriol, mannitol, sucrose and sorbitol.

The physical blowing agent is one or more compounds that have boiling temperatures (at 1 atmosphere pressure) of 10° C. to 80° C., preferably 10° C. to 50° C., and which lack hydroxyl, primary and/or secondary amine, thiol, carboxyl or other groups other than halogen groups that are reactive toward isocyanate groups under the conditions of the curing reaction. Useful physical blowing agents include hydrocarbons, hydrofluorocarbons, hydrochlorocarbons, hydrofluorochlorocarbons, ethers and the like that have the aforementioned boiling temperatures. C4-C6 hydrocarbons such as any isomer (or mixture of isomers) of butane, pentane and hexane are particularly useful. Also useful are hydrofluoroolefins and hydrofluorochloro olefins such as described, for example, in US 2007/0100010. Specific examples thereof are trifluoropropene, 1,3,3,3-tetrafluoropropene (1234ze), 1,1,3,3-tetrafluoropropene, 2,2,3,3-tetrafluoropropene (1234yf), 1,2,3,3,3-pentafluoropropene (1225ye), 1,1,1-trifluoropropene, 1,1,1,3,3-pentafluoropropene (1225zc), 1,1,2,3,3-pentafluoropropene (1225yc), (Z)-1,1,1,2,3-pentafluoropropene (1225yez), 1-chloro-3,3,3-trifluoropropene (1233zd) and 1,1,1,4,4,4-hexafluorobut-2-ene (1336mzzm). Mixture of any two or more physical blowing agents can be used.

The catalyst is a material that catalyzes the curing of the reactive foam formulation. Preferred catalysts include urethane catalysts, i.e., a catalyst for the reaction of an alcohol group and/or water with an isocyanate group, isocyanate trimerization catalysts, and carbodiimide catalysts. Among suitable urethane catalysts are tin (II) and tin (IV) catalysts, catalysts that contain other Group III to Group XV metals; tertiary amine compounds, amidines, tertiary phosphines, and the like. Useful isocyanate trimerization catalysts include strong bases such as alkali metal phenolates, alkali metal alkoxides, alkali metal carboxylates, quaternary ammonium salts, and the like. Useful carbodiimide catalysts include phospholene oxides such as 3-methyl-1-phenyl-2-phospholene oxide (MPPO), 3-methyl-1-ethyl-2-phospholene oxide (MEPO), 3,4-dimethyl-1-phenyl-3-phospholene oxide, 3,4-dimethyl-1-ethyl 3-phospholene oxide, 1-phenyl-2-phospholen-1-oxide, 3-methyl-1-2-phospholen-1-oxide, 1-ethyl-2-phospholen-1-oxide, 3-methyl-1-phenyl-2-phospholen-1-oxide, and 3-phospholene isomers thereof.

The reactive foam formulation may further contain various optional ingredients. A foam-stabilizing surfactant is a useful optional ingredient. Suitable such surfactants include, but are not limited to, silicones such as silicone oils and organosilicone-polyether copolymers, including polydimethyl siloxane and polydimethylsiloxane-polyoxyalkylene block copolymers. Other suitable surfactants include organic surfactants such as nonylphenol ethoxylates and ethylene oxide/butylene oxide block co-polymers.

Another optional ingredient is a flame retardant, such as a phosphorus-containing flame retardant, a halogenated flame retardant and melamine.

Water is another optional ingredient that, when present, reacts to produce carbon dioxide and provide auxiliary blowing.

In addition to the foregoing components, the formulated polyol composition or reaction mixture may contain one or more fillers and/or reinforcing agents such as fiber glass, carbon fibers, flaked glass, mica, talc, melamine and calcium carbonate; one or more pigments and/or colorants such as titanium dioxide, iron oxide, chromium oxide, azo/diazo dyes, phthalocyanines, dioxazines and carbon black; one or more biocides; one or more preservatives; one or more antioxidants; one or more flame retardants; and the like.

The corrugated facing layer is a rigid material that maintains its corrugated shape during the laminated panel manufacturing process. Examples of suitable materials of construction include metal sheets such as aluminum, iron or steel sheets, rigid thermoplastic polymers, rigid thermoset polymers and various rigid composites. The opposing facing layer also can be a such a rigid material material and may instead be a flexible material such as a metal, kraft or other paper, a fiber-reinforced paper, a metal foil-paper composite layer, a plastic sheet or film, or the like. Each facing layer preferably has a thickness of at most 10 mm, preferably up to 5 mm or up to 2.5 mm.

The foam layer of a laminated panel made in accordance with the invention may have a foam density of, for example, 20 to 120 kg/m³ or 30 to 80 kg/m³ as measured according to ASTM 1622-88. The cells may be at least about 70 percent closed, at least about 80 percent closed or at least about 85 percent closed.

Laminated panels made in accordance with the invention can be used in the same manner and for the same purposes as laminated panels made using conventional processes. The panels can be used as thermal insulation for buildings, pavement and other constructions. The panels are useful as lightweight decorative panels for building facades, interior wall partitions, and other uses. Laminated panels of the present invention are useful in both industrial and residential applications. Uses include, for example, cold stores insulation, doors, windows and sliding shutters. The laminated panels are also useful as a construction or decorative panel even when thermal insulation properties are not needed. The panels are useful, for example, in constructing building facades. The corrugations add to the mechanical strength of the laminated panels, rendering them suitable for load-bearing applications such as roofing panels and other non-horizontal installations.

The following example is provided to illustrate the invention but is not intended to limit the scope thereof. All parts and percentages are by weight unless otherwise indicated.

### Example 1 and Comparative Sample A

Corrugated roof panels one meter in width are made on a double band lamination line as generally described in FIG. 2. A corrugated facing layer as generally shown in FIG. 3 is passed beneath a distributor that dispenses a reactive foam formulation onto the corrugated facing layer through multiple outlets. The corrugated facing layer is made of steel and is 0.42 mm thick. It has four flat areas 12, each having a width W_{f} of 190 mm, which are separated by parallel trapezoidal corrugations 13 having a width W_{c} of 60 mm and a height He of 35 mm. The corrugated facing layer also has one lateral corrugation 13A having the same width and height as the parallel corrugations 13 separating the flat areas 12.

A flat steel opposing facing layer 0.42 mm thick is laid in downstream of the distributor at a set distance 40 mm above the corrugated facing layer. The resulting assembly is cured between the bands of the double band laminator to produce a laminated panel having corrugations on one side. During the curing process, the reactive foam formulation expands and cures to form a cured polymer foam the fills the corrugations and the gap between the corrugated and opposing facing layers.

In Comparative Sample A, the distributor is a rake-type apparatus as generally described in FIG. 1 of US 2014/0017412A1. This distributor has 24 outlets spaced evenly across its width. Several of these outlets are positioned directly over each of parallel corrugations 13 and lateral corrugations 13A and dispense reactive foam formulation into those corrugations.

In Example 1, the distributor is as generally shown in FIG. 3. It consists of four conduits of equal length, all extending from a single branch point 22. Each of the conduits has an opening 8, respectively centered over each of the four flat areas 12 of the corrugated facing layer. Each of the outlets 8 dispenses the reactive foam formulation at the same rate. A portion of the dispensed reactive foam formulation drains into corrugations 13 and 13A and expands and cures to produce a cured polymer foam that fills the entire space between corrugated facing layer 2 and opposing facing layer 3, including the corrugations.

The panels are cooled to room temperature. The tensile strength is determined according to EN 1607 on the full panel thickness including the facings. Adhesive strength is measured according to EN 1607 on samples having a 20-mm thick foam layer bonded to the flat facing layer. The target adhesive strength to each of the facings is 100 kPa. Density is determined according to EN 1602, while elastic modulus and compressive strength in the rise direction are determined according to EN 862. Results are as indicated in Table 1.

TABLE 1

| Property | Comp. Sample A | Example 1 |
|---|---|---|
| Foam Density, kg/m³ | 35.0 | 36.1 |
| Tensile Strength, kPa | 93.9 (flat side failure) | 110.6 (flat side failure) |
| Flat side adhesion, kPa | 88.5 | 114.4 |
| Foam elastic modulus, N/mm² | 4.02 | 3.85 |
| Foam Compressive Strength, kPa | 165 | 130 |

Foam density, elastic modulus and compressive strength are satisfactory in each case. Inadequate tensile strength and adhesion to the flat facing layer, which is the top layer in the manufacturing process, are persistent problems when making corrugated laminated panels using conventional processes. With this invention, both tensile strength and adhesion to to the top (flat) facing layers are improved very substantially.

When the flat facing layer is removed from Comparative Sample A, a significant number of defects are seen in the foam layer. These defects include indentations and other voids, which are believed to contribute to the poorer adhesion of the foam layer to the flat facing layer.

### Example 2 and Comparative Sample B

Example 1 is repeated using a different corrugated facing panel and a different distributor, to produce Example 2. The distributor used in making Example 2 is as shown generally in FIG. 4. The distributor consists of three conduits emanating from a single branch point, each conduit having an outlet 8 centered above a flat area 12 of the corrugated facing panel 2. The corrugated facing panel 2 used to make Example 2 and Comparative Sample B has three flat areas 12, each 293 mm in width, separated by two parallel corrugations 13. The parallel corrugations have a W_{c} of 40 mm and a He of 38 mm. A lateral corrugation 13A has the same dimensions as the parallel corrugations. Reactive foam formulation is dispensed from each outlet 8 at equal rates.

Comparative Sample B is made in the same manner as Comparative Sample A, except the corrugated facing panel is as described with regard to Example 2.

After curing and cooling, the opposing flat facing layer is removed from each of Example 2 and Comparative Sample B to inspect the surface of the foam layer. The exposed foam layer of Comparative Sample B exhibits a significant number of defects. In contrast, the exposed foam layer of Example 2 is almost defect-free.

### Example 3

This example illustrates the effect of blocking off openings in a distributor to adapt the distributor to dispense only onto flat areas of a corrugated facing panel. Turning to each of FIGS. 5, 6 and 7, a distributor of the general type described in FIG. 3 and accompanying text of WO 2012/045888 is shown. In this case, the distributor has two bifurcations and four outlets 8.

Without adaptation, this distributor will produce equal flow rates through each of the four outlets 8A-8D, i.e., for a total flowrate of 24 kg/min, each outlet of the distributor shown in FIG. 5 dispenses 6 kg of reactive foam formulation per minute.

In FIG. 5 (Comparative), outlets 8A, 8C and 8D are positioned over flat areas 12 and dispense reactive foam formulation onto the corresponding flat area. Outlet 8B is positioned over and dispenses reactive foam formulation onto one of the parallel corrugations 13.

In FIG. 6, outlet 8B is blocked off so the reactive foam formulation is dispensed only onto the flat areas 12 in accordance with the invention. Blocking outlet 8B causes the flow rates to become redistributed among outlets 8A, 8C and 8D. Under the same flow rate and assuming a fluid density of 1000 kg/m³ for the reactive foam formulation, a viscosity of 0.76 Pa·s, internal conduit diameters of 8 mm and branch lengths of 300 mm, the flow rate through outlet 8A increases to 10.16 kg/minute and the flow rates through outlets 8C and 8D increase to 6.87 kg/minute. In the FIG. 8 embodiment, about 50% more reactive foam formulation is dispensed onto one flat area 12 than onto the other two flat areas. This represents a less preferred operating condition.

In FIG. 7, outlet 8B is again blocked, but in this case outlet 8A is fitted with a restriction nozzle 19 mm long and having an inside diameter of 4 mm. This balances the flow rates through each of outlets 8A, 8C and 8D to 8 kg/minute, so reactive foam formulation is dispensed onto each of flat areas 12 at the same rate.

Generally, to obtain equal flow rates through multiple outlets, it is necessary to establish the same distributed pressure loss R_{distr} through each of the flow paths through the distributor to the outlets. For each flow path, R_{distr} is a function of friction factor f_{D}, conduit diameter D, path length L and average flow velocity W as follows:

$${R}_{distr} = {f}_{D} \frac{L}{D} \frac{{W}^{2}}{2} .$$

For laminar flow, f_{D} equals 64 divided by the Reynolds number, and the average flow velocity is given by

$$W = \frac{Q}{A}$$

wherein Q is the volumetric flowrate and A is the cross-sectional area of the conduit. By adjusting the length L and diameter D of each conduit, R_{distr} can be equilibrated across all openings. In the FIG. 7 embodiment, this is accomplished by increasing the overall length of the conduit and reducing its diameter by means of restriction nozzle 35.

1. A process for making a corrugated laminated panel, the process comprising the following steps:
I) continuously moving a corrugated facing layer in a linear direction of movement beneath a distributor having multiple outlets for dispensing jets of a reactive foam formulation onto the corrugated facing layer, wherein (i) the corrugated facing layer comprises multiple flat sections separated by multiple parallel corrugations, the flat sections having a width greater than or equal to the widths of the multiple parallel corrugations, (ii) the corrugated facing layer is disposed with the flat sections facing upwardly, and (iii) the multiple parallel corrugations extend downwardly from the flat sections and are oriented in the linear direction of movement of the corrugated facing layer beneath the distributor;
II) forming a reactive foam formulation layer by continuously dispensing jets of reactive foam formulation from the multiple outlets of the distributor only onto the flat sections of the corrugated facing layer as the corrugated facing layer moves beneath the distributor, such that the reactive foam formulation is dispensed onto each of the flat sections at rates per unit width that differ from each other by no more than 25%, whereby a portion of the reactive foam formulation dispensed onto the flat sections drains into the multiple parallel corrugations;
III) positioning a top facing layer above the reactive foam formulation layer and parallel to the corrugated facing layer to define a gap therebetween; and
IV) curing the reactive foam formulation layer between the corrugated facing layer and the top facing layer to expand the reactive foam formulation layer to fill the entire gap between the corrugated facing layer and the top facing layer, including the corrugations, and convert the reactive foam formulation layer to a cured foam layer, to produce the corrugated laminated panel comprising the cured foam layer adhered to the corrugated facing layer and the top facing layer.

2. The process of claim 1, wherein the multiple parallel corrugations have a height of from 20 to 70 mm.

3. The process of claim 1, wherein the multiple parallel corrugations have a width of up to 70 mm.

4. The process of claim 1, wherein the flat sections each have a width of at least 100 mm.

5. The process of claim 1, wherein the reactive foam formulation is dispensed onto each of the flat sections at rates per unit width that differ from each other by no more than 10%.

6. The process of claim 1, wherein in step II), the reactive foam formulation is dispensed onto each of the flat sections at the same rate per unit width.

7. The process of claim 1, wherein at least one of the multiple outlets of the distributor is closed.

8. The process of claim 1, wherein at least one of the multiple outlets of the distributor is positioned directly above a corrugation and is closed.

9. The process of claim 1, wherein at least one but fewer than all of the multiple outlets of the distributor is fitted with a restriction nozzle.

10. The process of claim 1, wherein at least one of the multiple outlets of the distributor is positioned directly above a corrugation and is fitted with a directing nozzle that directs a jet of reactive foam formulation dispensed from such outlet onto a flat section of the corrugated facing layer.

11. The process of claim 1, wherein step IV) is performed under mechanical pressure to gauge the corrugated laminated panel to a specified height.

12. The process of claim 1, wherein the top facing layer is flat.

13. A corrugated laminated panel made in accordance with the process of claim 1.
